(19) United States
(12) Patent Application Publication
(10) Pub. No.: US 2008/0085732 A1
(43) Pub. Date: Apr. 10, 2008

(54) COMMUNICATION TERMINAL APPARATUS, SERVER, AND RADIO COMMUNICATION SYSTEM

(75) Inventors: Rie MIZUIDE, Kanagawa (JP); Bo Zhao, Kanagawa (JP); Miho Kamasu, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/865,447

(22) Filed: Oct. 1, 2007

(30) Foreign Application Priority Data
Oct. 4, 2006 (JP) 2006-273375

(51) Int. Cl. H04Q 7/20

(52) U.S. Cl. 455/519

(57) ABSTRACT

A communication terminal apparatus, server, and radio communication system are provided that implement communication in a specific area subject to radio signal restrictions. The server 200 is equipped with a control section 201, a terminal control section 202, a database RAM section 203, a signal conversion control section 204, an ad hoc TX 205, an ad hoc RX 206, a radio TX 207, and a radio RX 208; mobile radio terminals 110 and 120 are equipped with a terminal function control section 111, a peripheral section 112, an ad hoc TX 113, an ad hoc RX 114, a radio TX 115, and a radio RX 116; and server 200 constructs a radio ad hoc network by means of terminal-server connection, and also transmits a control signal including inhibition of connection to a base station 300, and establishes ad hoc network connection on receiving a control signal from server 200.

### CROSS REFERENCE TO RELATED APPLICATIONS

The disclosure of Japanese Patent Application No. 2006-273375 filed on Oct. 4, 2006 including the specification, drawings and abstract is incorporated herein by reference in its entirety.

### BACKGROUND OF THE INVENTION

1. Field of the Invention

The present invention relates to a mobile radio terminal or suchlike communication terminal apparatus, a server, and a radio communication system, and more particularly to a server and radio connections forming a specific area, communication terminal apparatuses constructing an ad hoc network, and a server and radio communication system relating to communication and function control in communication terminal apparatuses.

2. Description of the Related Art

With the progress of radio communication technology and the Internet, the necessity of always performing radio communication with another server via a base station is disappearing. An ad hoc network that allows direct communication between users provides an era in which ubiquitous and constant radio connection is possible (see Non-patent Document 1, for example).
Non-patent Document 1: Susumu Yoshida “Future Perspective of Wireless Communications Technologies—Wireless Communication Technologies Permeating Daily Lives”, [online], (Technical report of IEICE, RCS 2004-23, pp. 127-132, April 2004) [Jul. 27, 2006 search] URL: http://yoshida.kuee.kyoto-u.ac.jp/publication/2004/y oshida04rcs04.pdf

However, the expansion of the utilization area of mobile radio terminals such as mobile phones has led to a problem of a signal transmitted from a mobile radio terminal interfering with the normal operation of nearby devices. In particular, restrictions on the use of mobile radio terminals, including mobile phones, have been introduced in specific areas such as hospitals where there is a fear of interference with life-sustaining devices.

A technology for implementing enforcement of usage restrictions in such specific areas is a call restriction method described in Patent Document 1 (Unexamined Japanese Patent Publication No. HEI 11-215562). With this call restriction method, a communication inhibition signal is transmitted within an area, and a mobile phone receiving this signal uses an internal signal analysis circuit to determine that use is restricted. When a mobile phone determines that use is restricted, it forcibly suspends transmission/reception, and turns its power off. With this method, also, control is performed so that a mobile phone's power is turned on automatically when the mobile phone user leaves a specific area in which a communication inhibition signal is transmitted.

However, with this kind of conventional mobile radio terminal, the fact that the power of a mobile phone is turned off indiscriminately inside a specific area such as a hospital or aircraft means that radio communication by means of a mobile phone is impossible within that specific area even in case of emergency. Also, it becomes impossible to contact a mobile phone that moves from outside that area to inside that area.

Moreover, implementing the technology described in Patent Document 1 requires a server constituting a restricting apparatus having the capability of transmitting a use inhibition signal throughout the specific area. Furthermore, there is a problem in that no provision is made for the need to vary the transmission range of the use inhibition signal according to an increase or decrease in the size of a specific area.

Even within a specific area, there are many cases in which it is not necessary to inhibit the transmission and reception of all kinds of signals from a mobile radio terminal. For example, in a hospital, in which interference with medical equipment is feared, calls by a PHS phone for medical use communicating by means of an extremely weak electromagnetic wave that does not affect nearby devices are permitted, and in a concert hall in which mobile phone calls are restricted, text communication, including e-mail, is still possible. It can therefore be considered to be necessary to implement different restriction controls for different situations within a specific area. It can be considered necessary to provide restrictions depending on specific circumstances, or restrictions for specific terminals, in different cases.

### SUMMARY OF THE INVENTION

It is an object of the present invention to provide a communication terminal apparatus, server, and radio communication system that implement communication in a specific area subject to radio signal restrictions.

According to an aspect of the invention, a communication terminal apparatus is provided that has a radio communication section that performs radio communication with a base station, an ad hoc network section that constructs a radio ad hoc network by means of inter-terminal radio connection, a section that receives a control signal including inhibition of radio connection to the base station, and a control section that establishes ad hoc network connection on receiving the control signal.

According to an aspect of the invention, a communication terminal apparatus is provided that has a radio communication section that performs radio communication with a base station, an ad hoc network section that constructs a radio ad hoc network by means of inter-terminal radio connection, a determination section that determines inhibition of radio connection, or impossibility of connection, to the base station, and a control section that establishes ad hoc network connection in accordance with the determination result.

According to an aspect of the invention, a server is provided that has a radio communication section that performs radio communication with a base station, an ad hoc network section that constructs a radio ad hoc network by means of inter-terminal radio connection, and a control section that transmits a control signal including inhibition of radio connection to the base station to a terminal.

According to another aspect of the invention, a radio communication system is provided that has a base station, and a communication terminal apparatus and server that perform radio communication with the base station; wherein the communication terminal apparatus has an ad hoc network section that constructs a radio ad hoc network by means of inter-terminal and terminal-server radio connection, a section that receives a control signal including inhibition of radio connection to the base station from the server, and a control section that establishes ad hoc network connection on receiving the control signal; and the server has an ad hoc network section that constructs a radio ad hoc network by means of terminal-server radio connection, and a control section that transmits a control signal including inhibition of radio connection to the base station to the communication terminal apparatus.

### BRIEF DESCRIPTION OF THE DRAWINGS

FIG. 1 is a drawing showing a radio communication system according to Embodiment 1 of the present invention;

FIG. 2 is a block diagram showing the configuration of a server and a mobile radio terminal composing a radio communication system according to the above embodiment;

FIG. 3 is a drawing showing the structure of a registration request signal used in communication via an ad hoc network of a radio communication system according to the above embodiment;

FIG. 4 is a drawing showing the structure of a connection cancellation signal used in communication via an ad hoc network of a radio communication system according to the above embodiment;

FIG. 5 is a drawing showing the structure of a communication connection control signal used in communication via an ad hoc network of a radio communication system according to the above embodiment;

FIG. 6 is a drawing showing the structure of a terminal function control signal used in communication via an ad hoc network of a radio communication system according to the above embodiment;

FIG. 7 is a drawing showing the structure of a control completion signal used in communication via an ad hoc network of a radio communication system according to the above embodiment;

FIG. 8 is a flowchart showing the processing content of the control section of a server of a radio communication system according to the above embodiment;

FIG. 9 is a flowchart showing the processing content of the terminal control section that controls the database RAM section of a server of a radio communication system according to Embodiment 2 of the present invention;

FIG. 10 is a flowchart showing communication connection selection control of a mobile-radio-terminal-side control section of a radio communication system according to Embodiment 3 of the present invention;

FIG. 11 is a flowchart showing transmission processing of a registration request signal in a radio communication system according to the above embodiment;

FIG. 12 is a flowchart showing terminal function control processing by a mobile-radio-terminal-side control section at the time of control signal reception in a radio communication system according to the above embodiment; and

FIG. 13 is a flowchart showing terminal function control processing by a mobile-radio-terminal-side control section at the time of ad hoc network disconnection in a radio communication system according to the above embodiment.

### DETAILED DESCRIPTION OF THE PREFERRED EMBODIMENTS

With reference now to the accompanying drawings, embodiments of the present invention will be explained in detail below.

### Embodiment 1

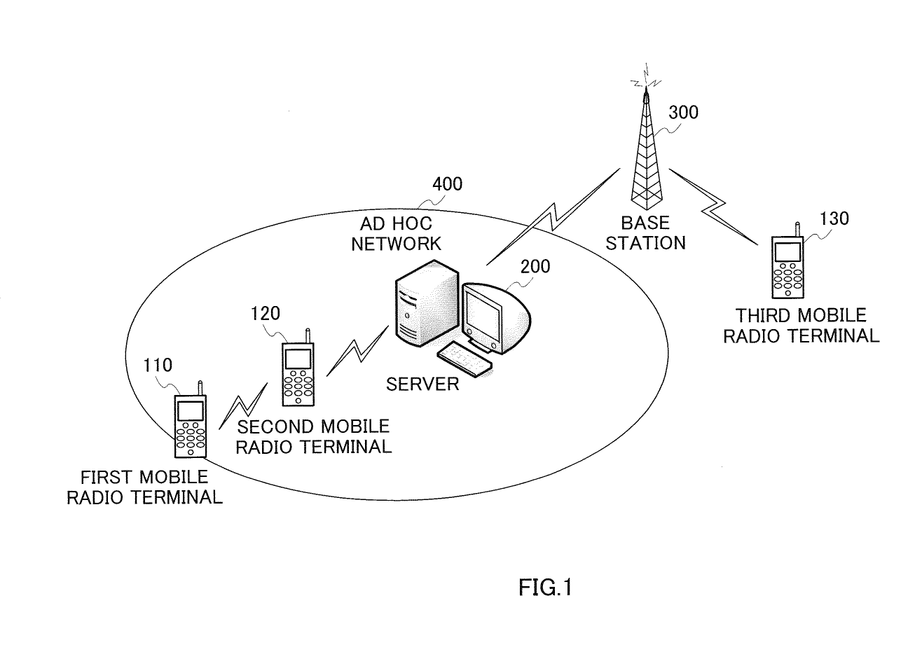

FIG. 1 is a drawing showing a radio communication system according to Embodiment 1 of the present invention. This embodiment is an example of application to a mobile phone as a mobile radio terminal.

In FIG. 1, the radio communication system is composed of a plurality of mobile radio terminals 110 through 130 (a first mobile radio terminal 110, a second mobile radio terminal 120, and a third mobile radio terminal 130) a server 200 that forms a specific area and controls communication and functions in mobile radio terminals 110 and 120, and a base station 300. Mobile radio terminals 110 and 120 and server 200 form an ad hoc network 400. In FIG. 1, third mobile radio terminal 130 is a mobile radio terminal outside the ad hoc network 400 area.

Mobile radio terminals 110 through 130 are mobile radio terminals such as mobile phones/PHS (Personal Handy-Phone System) phones, PDAs (Personal Digital Assistants), or the like, and have an ad hoc network connection function as a second communication means.

Ad hoc network 400 mutually connects a plurality of terminals via an Access Point by using short-range radio communication such as IEEE802.11x, Bluetooth (registered trademark), or UWB, for example.

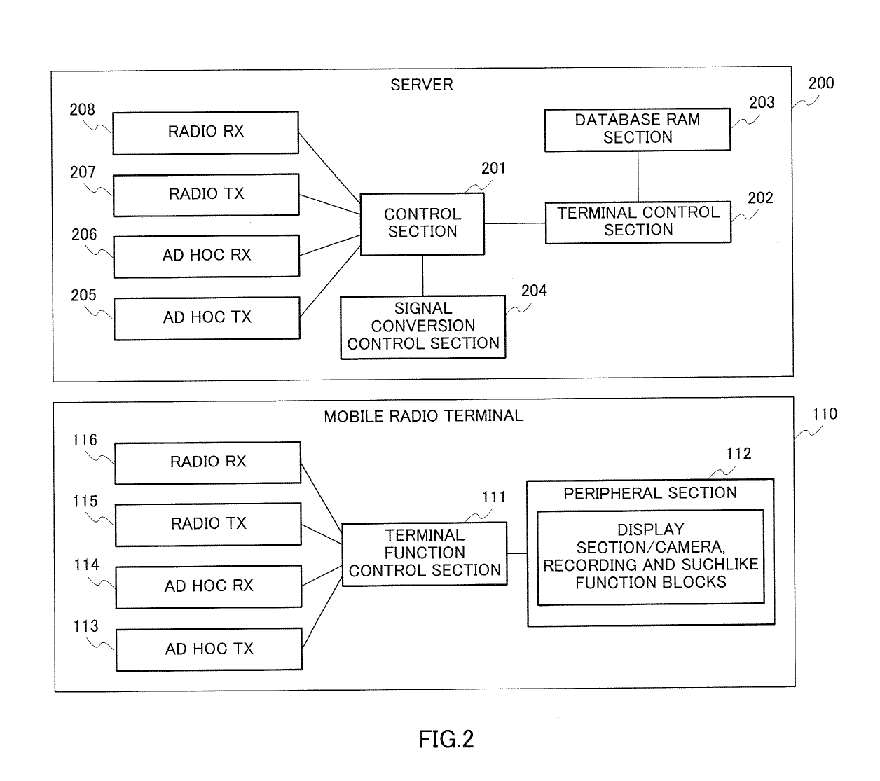

FIG. 2 is a block diagram showing the configuration of a server and a mobile radio terminal composing a radio communication system. Mobile radio terminals 110 and 120 have identical configurations, and therefore first mobile radio terminal 110 is shown here as a representative example.

In FIG. 2, server 200 comprises a server control section 201 that performs received signal analysis and server basic control, an intra-ad-hoc-network terminal control section 202 that performs control of terminals in ad hoc network 400, a database RAM section 203 that registers and stores terminal information as an intra-server terminal list, a signal conversion control section 204 that performs transmit/receive signal conversion between radio communication and communication via the ad hoc network, an ad hoc network signal transmitting section (hereinafter referred to as “ad hoc TX”) 205 that transmits a signal to ad hoc network 400, an ad hoc network signal receiving section (hereinafter referred to as “ad hoc RX”) 206 that receives a signal from ad hoc network 400, a base station radio signal transmitting section (hereinafter referred to as “radio TX”) 207 that transmits a signal to base station 300, and a base station radio signal receiving section (hereinafter referred to as “radio RX”) 208 that receives a signal from base station 300.

Control section 201 manages intra-area terminal user information in the area in which ad hoc network 400 is constructed. Server control section 201 also performs analysis of a received signal, and when a received signal is determined to be a communication signal, directs signal conversion control section 204 to perform signal conversion as necessary. When a received signal is determined to be a request signal, including a terminal registration request, terminal deletion request, or communication request, server control section 201 performs intra-server terminal list management.

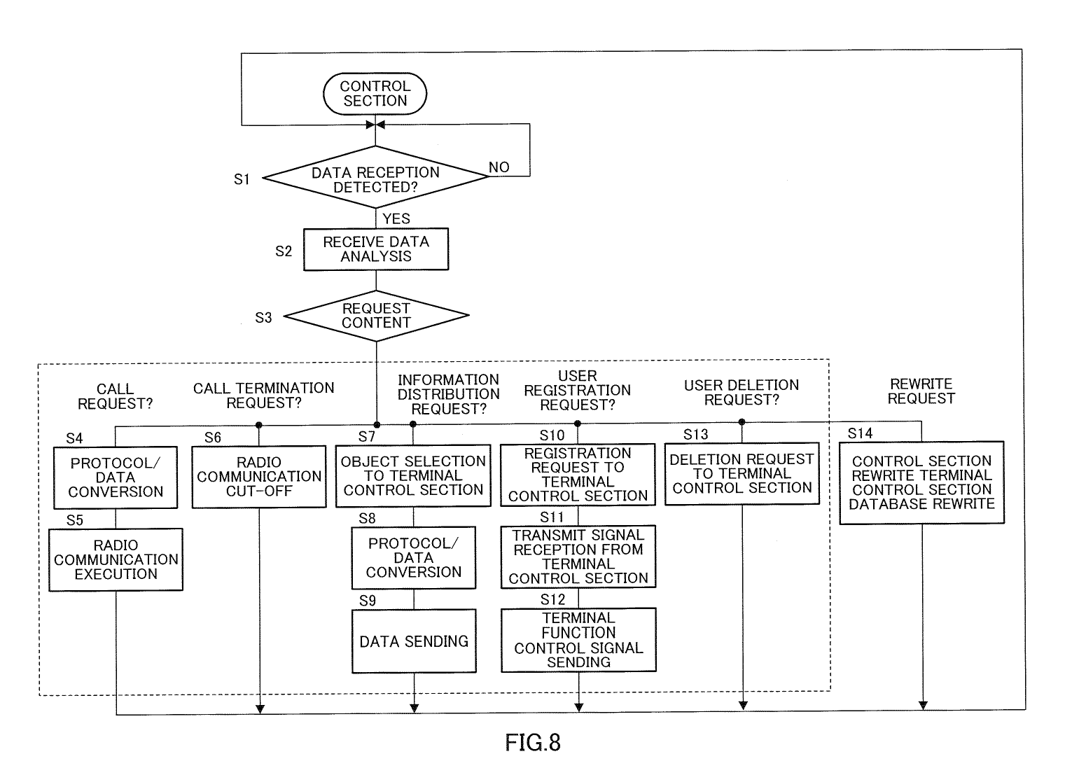

Specifically, when a terminal registration request signal is received, server control section 201 performs an intra-area terminal check, and if the received terminal information is not registered in the intra-server terminal list, adds the unregistered information to the intra-server terminal list. When an out-of-area communication request signal is received from an intra-area terminal, or a signal requesting communication to an intra-area terminal is received from a base station outside the ad hoc network area, server control section 201 confirms the presence of the intra-area terminal, and authorizes communication between base station 300 and the terminal via server 200. Server control section 201 also performs a deletion request terminal check when a terminal deletion request signal is received. Furthermore, if a terminal deletion request signal for a terminal registered in the intra-server terminal list is unconfirmed again for the same terminal in a stipulated period, server control section 201 performs deletion of terminal information in the intra-server terminal list as necessary. Control details will be given later herein with reference to the flowchart in FIG. 8.

When a communication request is authorized by server control section 201, terminal control section 202 gives a directive for a communication connection between a terminal and the server. Also, when function restriction is performed for all terminals, or a specific terminal, registered in the ad hoc network area, terminal control section 202 creates a forcible or selective restriction control signal, and gives a directive for its transmission.

Signal conversion control section 204 enables signal conversion between a radio communication signal within the ad hoc network area and a radio communication signal for a base station outside the area, as well as protocol conversion as necessary. It is desirable for both the server and an intra-area radio transmitting apparatus to have a signal conversion control section.

Meanwhile, first mobile radio terminal 110 comprises a terminal function control section 111 that performs overall terminal function control including ad hoc network communication and intra-terminal function control, a terminal peripheral section 112 that includes a display section/camera, and recording and suchlike function blocks, an ad hoc network signal transmitting section (hereinafter referred to as “ad hoc TX”) 113 that transmits a signal to ad hoc network 400, an ad hoc network signal receiving section (hereinafter referred to as “ad hoc RX”) 114 that receives a signal from ad hoc network 400, a base station radio signal transmitting section (hereinafter referred to as “radio TX”) 115 that transmits a signal to base station 300, and a base station radio signal receiving section (hereinafter referred to as “radio RX”) 116 that receives a signal from base station 300.

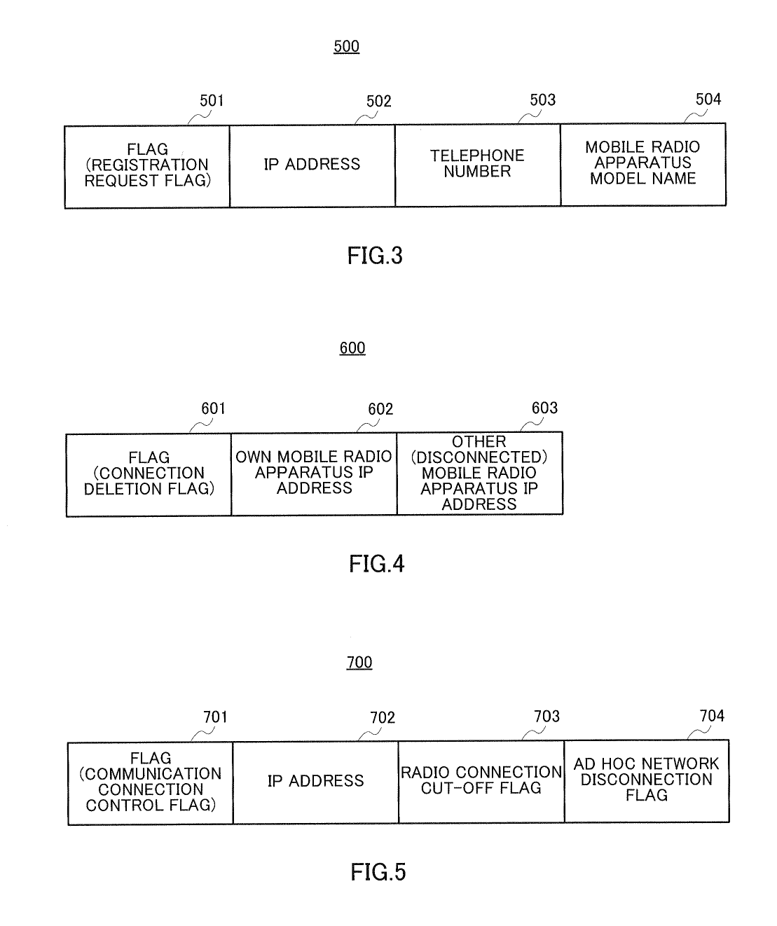

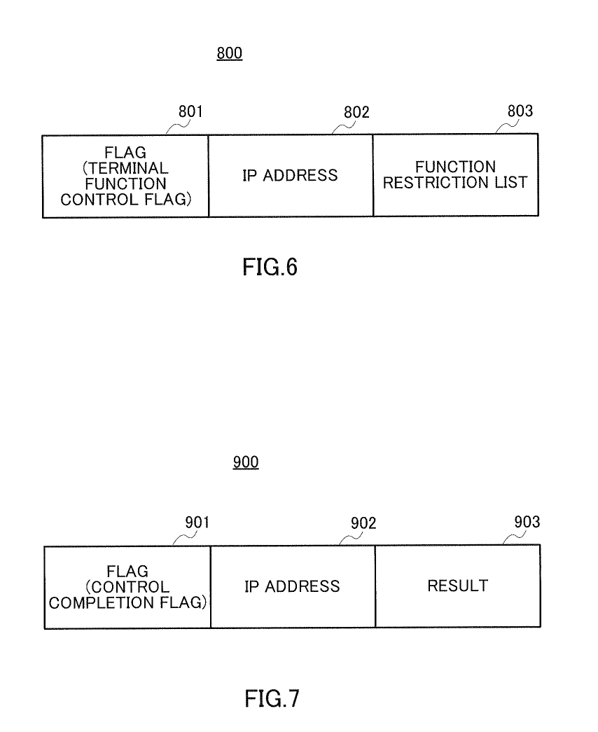

Terminal function control section 111 executes <communication connection selection control> that selectively switches between radio communication with base station 300 and server 200 or intra-area other user communication via ad hoc network 400, <communication establishment control> that analyzes a received signal and establishes communication between ad hoc network 400 terminals or a terminal and the server, and <terminal function control> that performs intra-terminal function control in accordance with the analyzed signal.

<Communication connection selection control> automatically performs requested communication connection switching or communication connection switching by means of terminal user selection when a control signal for which forcible communication connection conversion is requested is received from server 200 within the ad hoc network area.

<Communication establishment control> automatically transmits a registration request signal 500 (see FIG. 3) containing terminal information when ad hoc network connection of a terminal to another terminal or the server is determined to have been established. Also, when the ad hoc network area is exited and ad hoc network connection is cut, <communication establishment control> automatically issues a restriction cancellation request to a terminal. On the other hand, when connection to terminals for which connection was established via ad hoc network 400 is cut within the ad hoc network area, <communication establishment control> transmits connection deletion information 600 (see FIG. 4) containing information on those terminals to server 200. Also, if connection between another terminal and the server is requested via a terminal, <communication establishment control> establishes communication with a HUB in accordance with the request.

<Terminal function control> analyzes a received signal and causes a terminal to perform control in accordance with the analyzed signal. If the result of the analysis is that the received signal is a communication connection control signal 700 (see FIG. 5), <terminal function control> transmits a control completion signal 900 (see FIG. 7) to server 200 after processing has been performed by <communication connection selection control>. Similarly, if the analyzed signal is determined to be a terminal function control signal 800 (see FIG. 6), <terminal function control> transmits a control completion signal 900 (see FIG. 7) to server 200 after the requested function control has been performed. Then, if the terminal is determined to be outside the ad hoc network area, and restriction cancellation is requested, <terminal function control> cancels all restrictions imposed on the terminal.

According to above-described server 200 and mobile radio terminals 110 through 130, it is possible for intra-area terminal usage control to be executed dependably by server 200 within the restriction area in which ad hoc network 400 is constructed.

FIG. 3 through FIG. 7 are drawings showing the structure of signals used in communication via ad hoc network 400. FIG. 3 shows the structure of registration request signal 500, FIG. 4 the structure of connection deletion signal 600, FIG. 5 the structure of communication connection control signal 700, FIG. 6 the structure of terminal function control signal 800, and FIG. 7 the structure of control completion signal 900.

In FIG. 3, registration request signal 500 is composed of a flag 501, an IP address 502, a telephone number 503, and a mobile radio apparatus model name 504.

Flag 501 is a flag indicating that this is a registration request signal. IP address 502 is an IP address used in the case of an ad hoc network. Telephone number 503 is the telephone number of a mobile radio terminal. For example, it is possible to determine whether a server is a pre-registered user in a concert hall or the like, and to use telephone number 503 when performing identification in order to enable radio connection for an authorized mobile radio terminal in a specific area in which radio connection is prohibited. Mobile radio apparatus model name 504 is the model name of a mobile radio terminal, which is information necessary when server 200 creates a control signal in terminal control section 202, for example.

In FIG. 4, connection deletion signal 600 is composed of a flag 601, an own mobile radio apparatus IP address 602, and an other (disconnected) mobile radio apparatus IP address 603.

With a connection deletion signal, it is possible for information—information on the content indicated by 601 through 603 being mainly assumed—to be increased or decreased arbitrarily.

Flag 601 is a flag indicating that this is a connection deletion signal. Own mobile radio apparatus IP address 602 is an IP address used in the case of an ad hoc network of the mobile radio terminal itself. Other (disconnected) mobile radio apparatus IP address 603 is an IP address of a disconnected other mobile radio terminal. By receiving this information, server 200 can delete information for a disconnected other mobile radio terminal registered in the area user information database.

In FIG. 5, communication connection control signal 700 is composed of a flag 701, an IP address 702, a radio connection cut-off flag 703, and an ad hoc network disconnection flag 704.

Flag 701 is a flag indicating that this is a communication connection control signal. IP address 702 is an IP address used in the case of an ad hoc network. Radio connection cut-off flag 703 is a flag indicating whether or not a radio connection is to be cut. Ad hoc network disconnection flag 704 is a flag indicating whether or not an ad hoc network is to be disconnected.

In FIG. 6, terminal function control signal 800 is composed of a flag 801, an IP address 802, and a function restriction list 803.

Flag 801 is a flag indicating that this is a terminal function control signal. IP address 802 is an IP address used in the case of an ad hoc network. Function restriction list 803 is used by server 200 to restrict mobile radio terminal functions. Function restriction list 803 is created by server 200 based on a mobile radio terminal model name of registration request signal 500 transmitted to server 200 in accordance with <communication establishment control> described later herein.

In FIG. 7, control completion signal 900 is composed of a flag 901, an IP address 902, and a result 903.

Flag 901 is a flag indicating that this is a control completion signal. IP address 902 is an IP address used in the case of an ad hoc network. Result 903 is information as to whether or not content specified by a control signal terminated normally.

The operation of a radio communication system having the above configuration will now be described.

### [Overall Operation of Radio Communication System]

In this embodiment, by installing a server 200 in a specific ad hoc network 400, function restrictions including transmission and reception are implemented for a mobile communication terminal 110 in the specific ad hoc network 400 area via server 200.

As shown in FIG. 1, first mobile radio terminal 110, second mobile radio terminal 120, and server 200 are within the specific ad hoc network 400 area. Also, second mobile radio terminal 120 is a mobile radio terminal for which only communication via ad hoc network 400 is possible.

When first mobile radio terminal 110 detects ad hoc network 400, terminal function control section 111 of first mobile radio terminal 110 creates a registration request signal 500 (see FIG. 3). Ad hoc TX 113 sends registration request signal 500 to second mobile radio terminal 120 directly connected via ad hoc network 400.

Second mobile radio terminal 120 receives the registration request signal from first mobile radio terminal 110 by means of ad hoc RX 114, and terminal function control section 111 performs signal analysis. Then ad hoc TX 113 sends registration request signal 500 to server 200.

In server 200, server ad hoc RX 206 receives registration request signal 500 transmitted from second mobile radio terminal 120, and server control section 201 performs signal analysis. Then server control section 201 references server database RAM section 203 and determines first mobile radio terminal 110 terminal information registration.

Next, when first mobile radio terminal 110 control is performed by server 200, terminal control section 202 in server 200 first creates a control signal. Then server 200 sends the control signal created by server ad hoc TX 205 to ad hoc network 400.

First mobile radio terminal 110 receives the control signal from ad hoc RX 114 on the terminal side via second mobile radio terminal 120. Terminal function control section 111 of first mobile radio terminal 110 performs signal analysis of the received control signal, and performs control of the entire terminal including terminal peripheral section 112 in the terminal in accordance with the control signal.

Also, when first mobile radio terminal 110 performs communication to third mobile radio terminal 130 outside the ad hoc network 400 area via ad hoc network 400, terminal function control section 111 of first mobile radio terminal 110 creates a communication request signal, and ad hoc TX 113 sends the created communication request signal.

In server 200, server ad hoc RX 206 receives the communication request signal via second mobile radio terminal 120, and server control section 201 performs signal analysis. Then server control section 201 references server database RAM section 203 and performs a communication request terminal information check. If communication authorization is obtained as a result of this check, server radio TX 207 sends a communication request signal to base station 300.

Subsequently, after communication is established, server radio RX 206 of server 200 receives a communication signal from base station 300. Then server control section 201 performs signal analysis. Signal conversion control section 204 converts the communication signal as necessary. Server ad hoc TX 205 transmits the converted communication signal to first mobile radio terminal 110 via second mobile radio terminal 120.

A description will now be given of a case in which third mobile radio terminal 130 outside the ad hoc network 400 area wishes to communicate with second mobile radio terminal 120, which is within the ad hoc network 400 area and can only communicate via ad hoc network 400. In this case, a communication request signal from base station 300 is received by server radio RX 206 of server 200. Server control section 201 performs signal analysis of the received signal. Terminal control section 202 references data in server database RAM section 203, and checks the request terminal information obtained from the information analysis result. If communication authorization is obtained as a result of the check, server ad hoc TX 205 transmits a communication request signal to second mobile radio terminal 120.

A case in which first mobile radio terminal 110 moves outside the ad hoc network 400 area will now be considered. In second mobile radio terminal 120, which was connected directly via ad hoc network 400, terminal function control section 111 creates a first mobile radio terminal 110 deletion request signal 600 (FIG. 4). Ad hoc TX 113 sends the created deletion request signal 600 to server 200.

Server ad hoc RX 206 of server 200 receives deletion request signal 600. Server control section 201 performs signal analysis. Then terminal control section 202 updates server database RAM section 203 and performs determination of first mobile radio terminal 110 information deletion.

Here, control section 201 of server 200 performs the above-described control for radio RX 208, radio TX 207, ad hoc RX 206, and ad hoc TX 205, and sets communication enabling/disabling in radio RX 208, radio TX 207, ad hoc RX 206, and ad hoc TX 205 units as necessary.

A mode is also possible in which control section 201 execution program updates, rewrites, and deletion requests, and server-side database RAM section 203 database updates, rewrites, and deletion requests, are performed via radio RX 208, ad hoc RX 206, or a UI (user interface) block connected to server 200.

### [Server Operation]

FIG. 8 is a flowchart showing the processing content of control section 201 of server 200. In this flowchart, “S” denotes a step of the procedure.

In step S1, control section 201 detects data sent to server 200. When data addressed to server 200 is detected, in step S2 the content of the sent receive data is analyzed, and in step S3 request content analysis is performed. Receive data from a terminal includes, in addition to protocol and request data, data corresponding to request content stored in request data—that is, terminal information data, and media data such as audio data, video data, and text data—and information such as rewrite program data and database information.

Depending on the received request content, control section 201 branches to processing in step S4, step S6, step S7, step S10, step S13, or step S14.

If the received request content is a “rewrite request”, receive data includes information indicating administrator authorization, change content, and change information. If a control section 201 program is subject to rewriting, a change is made at the relevant place in step S14. In the case of a database RAM section 203 rewrite, control section 201 issues a change request to terminal control section 202.

The part enclosed by a dotted line in FIG. 8 indicates processing defined in rewritable areas.

If the received request content is a “call request” requiring radio communication with base station 300, receive data includes a network address or sending terminal information acquired by the terminal, audio information, and call destination terminal information. In step S4, data is converted from the ad hoc network communication protocol to a radio communication protocol, and a data format supported in radio communications, for signal conversion control section 204. In step S5, a call is executed using radio TX 207 and radio RX 208. When received request content is uplink audio or downlink audio for a call, information is sent from the respective network via signal conversion control section 204 in the same way as described above.

If the received request content is a “call termination request” that cuts radio communication with base station 300, receive data includes a network address or sending terminal information, and call destination terminal information. In step S6, control section 201 disconnects radio RX 208 and radio TX 207.

If the received request content is an “information distribution request”, receive data includes a sending destination condition and distribution information. In step S7, control section 201 makes a data transmission object inquiry to terminal control section 202, and in step S8, signal conversion control section 204 performs protocol and data conversion as necessary. In step S9, information distributed from ad hoc TX 205 is sent to the relevant terminal as data for transmission.

If the received request content is a terminal “user registration request”, receive data includes a network address and terminal information. In step S10, control section 201 issues a terminal registration request to terminal control section 202. According to the area, in step S11 check processing is performed for terminal control section 202 as to whether or not the user is an authorized user registered beforehand in database RAM section 203. Also, a terminal control signal is created according to the terminal and situation for which registration was requested. Then in step S12, ad hoc TX 205 transmits the created terminal control signal to the relevant terminal.

If the received request content is a “user deletion request”, receive data includes network address information assigned to a terminal. Instep S13, control section 201 issues a request for deletion of terminal registration information to terminal control section 202. However, in the case of an area for which entry/exit management is recorded, or the like, all data is not necessarily deleted from the database.

As described in detail above, according to this embodiment, server 200 has a control section 201, a terminal control section 202, a database RAM section 203, a signal conversion control section 204, an ad hoc TX 205, an ad hoc RX 206, a radio TX 207, and a radio RX 208. Mobile radio terminals 110 and 120 have a terminal function control section 111, a terminal peripheral section 112, an ad hoc TX 113, an ad hoc RX 114, a radio TX 115, and a radio RX 116. Server 200 constructs a radio ad hoc network by means of terminal-server radio connections, and transmits control signals including inhibition of radio connection to base station 300 to mobile radio terminals 110 and 120. When a control signal is received from server 200, an ad hoc network connection is established, making control possible on a user-by-user basis by having server 200 manage user information and form an ad hoc network 400.

In an example of the prior art, if radio connection to a base station becomes impossible, a terminal must move to a location where radio connection is possible. In particular, there have been situations in which radio contact by means of a mobile phone becomes impossible even in an emergency when radio connection to a base station becomes impossible, or because mobile phone power is turned off indiscriminately within a specific area, and a mobile phone within the area cannot be contacted from outside the area. With this embodiment, on the other hand, communication is possible via ad hoc network 400, and radio connection and information distribution are possible only for a specified user in a specific area for which radio communication is inhibited or a specific area in which various kinds of are distributed.

The effects of this embodiment will be described in detail by means of a comparison with an example of the prior art.

(1) In an example of the prior art, if radio connection to a base station becomes impossible, it is necessary to move to a location where radio connection is possible. In this embodiment, an ad hoc network is formed automatically, enabling a user to be constantly connected to a network without being aware that radio connection is impossible.

(2) In this embodiment, a user can switch between radio connection and an ad hoc network at will, making it possible for radio connection/ad hoc network switching to be performed according to a user's needs.

(3) In an example of the prior art, in the case of a specific area for which radio connection is inhibited, for example, all radio connections are impossible for a user in the specific area. In this embodiment, it is possible for a specified user to perform radio connection even within the specific area.

(4) In an example of the prior art, in the case of a specific area for which various kinds of information are distributed, for example, a user in the specific area receives all of the various kinds of information. In this embodiment, it is possible for various kinds of information to be distributed only to a specified user, or only to a user other than a specified user, even within the specific area.

### Embodiment 2

In Embodiment 2, the operation of server 200 will be described in further detail.

The hardware configuration of a radio communication system according to Embodiment 2 is the same as the configuration of a communication terminal apparatus according to Embodiment 1 shown in FIG. 2.

In this embodiment, database RAM section 203 shown in FIG. 2 includes the following database in addition to a database storing terminal information. Namely, server database RAM section 203 databases have (1) area user information on users of an ad hoc network service within an area, and (2) group user information in which control information for each terminal within an area is registered.

As above-mentioned group user information, an insider is registered in an area in which security is necessary, such as a company or research institute, for example. Group user information is used to distinguish connection to an outside intruder or terminal function restrictions. Also, in the case of a concert hall for which users who have purchased tickets in advance have been registered, group user information can be used in implementing a service such as distributing lyrics only to purchasers of tickets.

Types of information registered in the area user information database include terminal information, network address, radio channel usage status, and so forth. Types of information registered in the group user information database include terminal information, terminal function restriction content, and so forth.

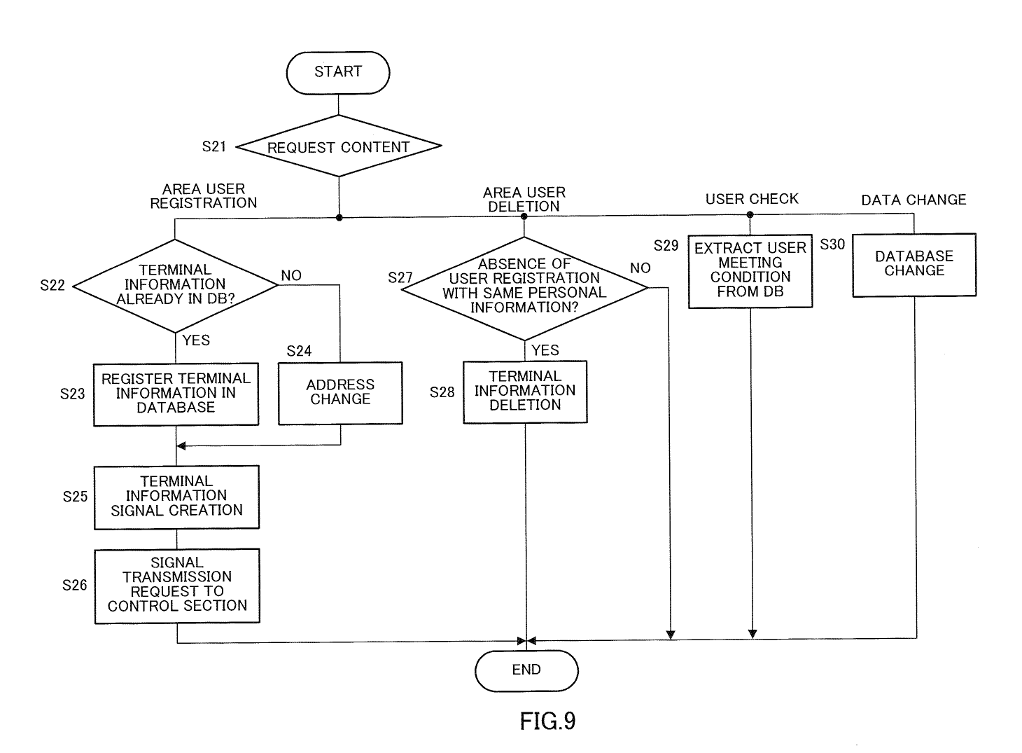

FIG. 9 is a flowchart showing the processing content of terminal control section 202 that controls above-described server database RAM section 203.

In step S21, terminal control section 202 performs determination of the request content specified by control section 201 of server 200. If the specified request content is area user registration, in step S22 terminal control section 202 performs a search to find whether or not terminal information already exists in the area user information database.

If terminal information exists, in step S23 terminal control section 202 registers terminal information in the area user information database. If terminal information does not exist, terminal control section 202 determines that there is a possibility that the network address has been changed, and in step S24 changes a network address in the area user information database.

In step S25, terminal control section 202 creates a terminal control signal, and instep S26 terminal control section 202 requests server control section 201 to transmit the created terminal control signal. This terminal control signal includes terminal ring tone switch information, terminal radio RX 116 and radio TX 115 switch information, call restriction information, mobile phone power supply unit switch information, and information as to whether these are forcible operations or recommended operations.

If the request content specified by control section 201 instep S21 is area user deletion, in step S27 terminal control section 202 monitors whether or not there is registration of an area user having that terminal information for a certain time. If there is registration of an area user having the terminal information, terminal control section 202 performs a network address change and terminates processing. If there is no area user registration, in step S28 terminal control section 202 deletes registration information for the relevant terminal from the area user information database. However, if an entry/exit log is necessary, all data does not necessarily need to be deleted.

If the request content specified by control section 201 in step S21 is a user check, in step S29 terminal control section 202 takes network address data from the group user information database, extracts a user with the specified condition content, and terminates the processing.

If the request content specified by control section 201 in step S21 is a group user information database change, in step S30 terminal control section 202 performs the specified user registration/deletion/amendment and terminates the processing.

### Embodiment 3

In Embodiment 3, the operation of a mobile radio terminal will be described in detail.

The hardware configuration of a radio communication system according to Embodiment 3 of the present invention is the same as the configuration of Embodiment 1 shown in FIG. 2.

In this embodiment, in addition to radio RX 116, radio TX 115, ad hoc RX 114, ad hoc TX 113, and terminal peripheral section 112 control, terminal function control section 111 of modulation section 1110 shown in FIG. 2 also executes <communication connection selection control> that automatically or selectively switches between radio communication with base station 300 and server 200 or intra-area other user communication via ad hoc network 400, <communication establishment control> that establishes communication between ad hoc network 400 mobile radio terminals or a mobile radio terminal and the server, and <terminal function control> that performs intra-terminal function control in accordance with an analyzed signal.

### [Communication Connection Selection Control]

First, above-mentioned <communication connection selection control> will be described. <Communication connection selection control> makes it possible to select ad hoc network construction by means of a user switching operation when, for example, automatic construction of ad hoc network 400 is selected as a communication means when radio communication with base station 300 has become impossible for mobile radio terminals 110, 120, and 130, and when radio communication with base station 300 is possible.

Alternatively, it is possible for radio connection to be cut and ad hoc network construction to be selected forcibly when forcible communication connection conversion is requested.

A mode may also be used in which a user I/F is provided that sets whether ad hoc network 400 is constructed automatically, or switching/non-switching is determined by a user switching operation, when radio communication with base station 300 becomes impossible.

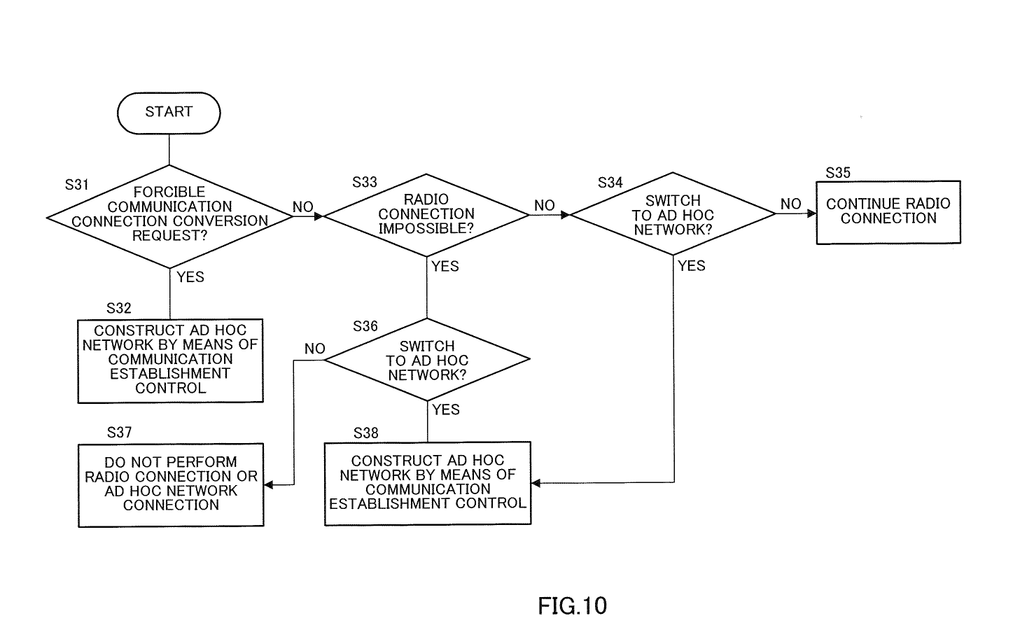

FIG. 10 is a flowchart showing communication connection selection control of mobile-radio-terminal-side terminal function control section 111.

First, in step S31, terminal function control section 111 determines whether or not forcible communication connection conversion has been requested, and if forcible communication connection conversion has been requested, in step S32 terminal function control section 111 constructs ad hoc network 400 by means of <communication establishment control>.

If it is determined in above step S31 that forcible communication connection conversion has not been requested, in step S33 terminal function control section 111 determines whether or not radio connection is impossible. If radio connection is not impossible, in step S34 terminal function control section 111 determines whether or not to switch to ad hoc network 400. If a setting has been made for ad hoc network 400 to be constructed automatically by means of the user I/F, in step S38 ad hoc network 400 is constructed automatically, whereas if such a setting has not been made, the user makes a selection via the user I/F.

If ad hoc network construction has been selected by means of the user I/F, in step S38 terminal function control section 111 constructs an ad hoc network, whereas if ad hoc network 400 construction has not been selected, in step S35 terminal function control section 111 does not construct an ad hoc network but continues radio connection.

On the other hand, if radio connection is determined to be impossible in step S33, in step S36 terminal function control section 111 determines whether or not to switch to ad hoc network 400. If ad hoc network 400 construction has not been selected, in step S37 terminal function control section 111 does not continue radio connection or ad hoc network 400. If it is determined in step S36 that ad hoc network 400 is to be constructed, in step S38 ad hoc network 400 is constructed by means of communication establishment control.

### [Communication Establishment Control]

Next, <communication establishment control> will be described. In <communication establishment control>, terminal function control section 111 implements the following three controls (1) through (3).

Control (1): <Communication establishment control> implements radio connection with base station 300 and ad hoc network 400 inter-terminal and terminal-server communication establishment.

Control (2): <Communication establishment control> automatically transmits a registration request signal 500 (see FIG. 3) containing mobile radio terminal information when ad hoc network connection of a terminal to another terminal or the server is determined to have been established.

Control (3): <Communication establishment control> automatically issues a restriction cancellation request to a mobile radio terminal when the ad hoc network area is exited and ad hoc network connection is cut. On the other hand, when connection to a terminal for which connection was established via an ad hoc network is cut within the ad hoc network area, <communication establishment control> transmits a connection deletion signal 600 (see FIG. 4) containing information on that terminal to server 200.

In above control (1), radio RX 116 and radio TX 115 perform signal transmission/reception and radio connection, and ad hoc RX 114 and ad hoc TX 113 perform signal transmission/reception and ad hoc network connection. In the case of an ad hoc network, ad hoc RX 114 receives an ad hoc network construction request from server 200 or another mobile radio terminal, and terminal function control section 111 establishes communication as a HUB.

In above control (2), terminal function control section 111 determines that ad hoc network connection has been established by above control (1), and ad hoc TX 113 transmits a registration request signal 500 (see FIG. 3) to server 200.

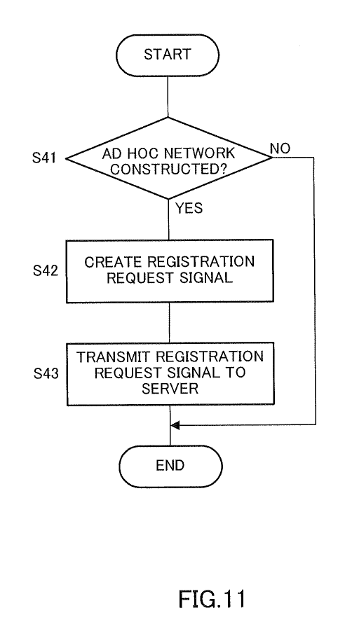

FIG. 11 is a flowchart of registration request signal 500 transmission processing in above control (2).

First, in step S41, terminal function control section 111 determines whether or not ad hoc network 400 has been constructed, and if ad hoc network 400 has been constructed, in step S42 terminal function control section 111 creates a registration request signal 500 (see FIG. 3). Next, in step S43, terminal function control section 111 has ad hoc TX 113 transmit the created registration request signal 500 to server 200. If it has been determined in above step S41 that ad hoc network 400 has not been constructed, terminal function control section 111 terminates processing directly and does not perform creation or transmission of a registration request signal 500.

In above control (3), when terminal function control section 111 recognizes that ad hoc network connection to server 200 has been cut, terminal function control section 111 controls ad hoc RX 114 and cancels a mobile radio terminal function restricted when ad hoc RX 114 received a control signal by means of <terminal function control>.

Also, when terminal function control section 111 recognizes that ad hoc network connection to another mobile radio terminal has been cut, terminal function control section 111 controls ad hoc TX 113, and ad hoc TX 113 transmits a deletion request signal 600 (see FIG. 4) for the disconnected other mobile radio terminal to server 200.

### [Terminal Function Control]

Next, <terminal function control> will be described. Terminal function control section 111 performs analysis of a received signal received by ad hoc RX 114 by means of <terminal function control>. In this received signal analysis, terminal function control section 111 determines whether the signal is a communication connection control signal 700 (see FIG. 5) or another terminal function control signal 800 (see FIG. 6). If the signal is a communication connection control signal 700, terminal function control section 111 transmits a control completion signal 900 (see FIG. 7) to server 200 by controlling ad hoc TX 113 after performing processing by means of above-described <communication connection selection control>.

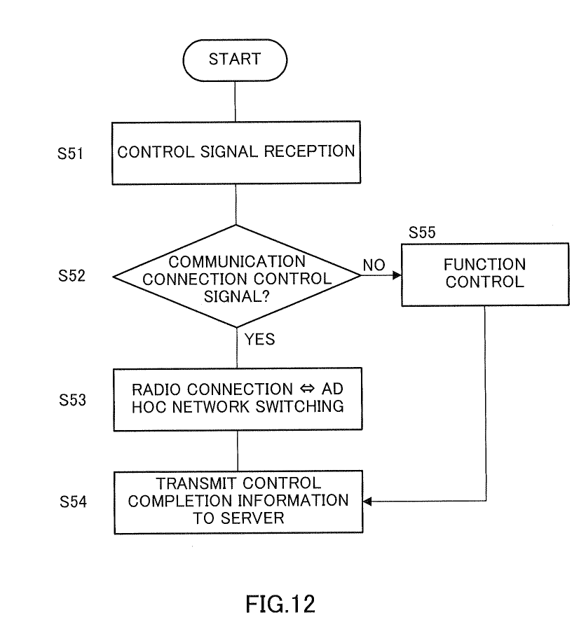

FIG. 12 is a flowchart showing terminal function control processing by mobile-radio-terminal-side terminal function control section 111 at the time of control signal reception.

First, in step S51, terminal function control section 111 receives a control signal, and in step S52 terminal function control section 111 analyzes whether the received signal is a communication connection control signal 700 (see FIG. 5) or another terminal function control signal 800 (see FIG. 6). If the received signal is a communication connection control signal 700, in step S53 terminal function control section 111 performs radio connection/ad hoc network 400 switching using above-described “communication connection selection control” and “communication establishment control”. When switching ends, in step S54 a control completion signal 900 (see FIG. 7) is transmitted to server 200.

If terminal function control section 111 determines in above step S52 that the received signal is another terminal function control signal 800 (see FIG. 6), in step S55 terminal function control section 111 restricts some or all of the mobile radio terminal's peripheral section 112, ad hoc TX 113, ad hoc RX 114, radio TX 115, and radio RX 116 functions according to the analysis result, and proceeds to above step S54.

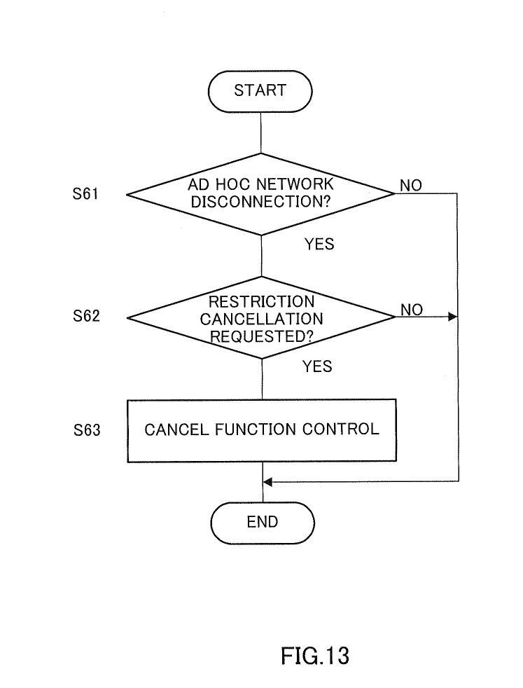

FIG. 13 is a flowchart showing terminal function control processing by mobile-radio-terminal-side terminal function control section 111 at the time of ad hoc network disconnection.

First, if terminal function control section 111 recognizes in step S61 that ad hoc RX 114 has cut ad hoc network connection to server 200, in step S62 terminal function control section 111 determines whether or not restriction cancellation has been requested by above-described <communication establishment control>. If restriction cancellation has been requested, in step S63 a mobile radio terminal function restricted when a control signal was received is canceled and the processing is terminated. If the determination result in above step S61 is not ad hoc network disconnection, or if it is determined in above step S62 that restriction cancellation has not been requested, there is determined not to be a function control cancellation condition, and the processing is terminated.

The above description illustrates preferred embodiments of the present invention, and the scope of the present invention is not limited thereto.

In the above embodiments, mobile phones have been described as mobile radio terminals, but this is only one example and it is possible for the present invention to be applied to any apparatus that performs ad hoc network connection, and there are no limitations as to types or number of communication methods.

In the above embodiments, the terms “radio communication system”, “mobile radio terminal”, and “server” have been used, but this is only for the sake of explanation, and terms such as “mobile terminal”, “radio communication apparatus”, “radio communication control method”, and so forth may of course also be used.

Types, numbers, connection methods, and so forth of circuit parts composing an above-described radio communication system are not limited to the above-described embodiments.

An above-described radio communication system is also implemented by means of a program for causing this radio communication system to function. This program is stored in a computer-readable recording medium.

As described above, according to the present invention an ad hoc network can be formed automatically, and it is possible for a user to be constantly connected to a network without being aware that radio connection is impossible.

Also, a user can switch between radio connection and an ad hoc network at will, enabling radio connection/ad hoc network switching to be performed according to a user's needs.

Therefore, a communication terminal apparatus, server, and radio communication system according to the present invention are useful for a server and radio connection that form a specific area, and a radio system that constructs an ad hoc network.

What is claimed is:

1. A communication terminal apparatus comprising:
a radio communication section that performs radio communication with a base station;
an ad hoc network section that constructs a radio ad hoc network by means of inter-terminal radio connection;
a section that receives a control signal including inhibition of radio connection to the base station; and
a control section that establishes ad hoc network connection on receiving the control signal.

2. A communication terminal apparatus comprising:
a radio communication section that performs radio communication with a base station;
an ad hoc network section that constructs a radio ad hoc network by means of inter-terminal radio connection;
a determination section that determines inhibition of radio connection, or impossibility of connection, to the base station; and
a control section that establishes ad hoc network connection in accordance with the determination result.

3. A server comprising:
a radio communication section that performs radio communication with a base station;
an ad hoc network section that constructs a radio ad hoc network by means of inter-terminal radio connection; and
a control section that transmits a control signal including inhibition of radio connection to the base station to a terminal.

4. The server according to claim 3, further comprising a management section that manages intra-ad-hoc-network terminal information,
wherein the control section transmits the control signal to a specific terminal only.

5. A radio communication system that has abase station, and a communication terminal apparatus and server that perform radio communication with the base station, wherein:
the communication terminal apparatus comprises:
an ad hoc network section that constructs a radio ad hoc network by means of inter-terminal and terminal-server radio connection;
a section that receives a control signal including inhibition of radio connection to the base station from the server; and
a control section that establishes ad hoc network connection on receiving the control signal, and
the server comprises:
an ad hoc network section that constructs a radio ad hoc network by means of terminal-server radio connection; and
a control section that transmits a control signal including inhibition of radio connection to the base station to the communication terminal apparatus.

6. The radio communication system according to claim 5, wherein:
the communication terminal apparatus further comprises a determination section that determines inhibition of radio connection, or impossibility of connection, to the base station, and
the control section establishes ad hoc network connection in accordance with the determination result.
